(19) United States
(12) Patent Application Publication
(10) Pub. No.: US 2026/0149900 A1
(43) Pub. Date: May 28, 2026

(54) IMAGING DEVICE

(71) Applicant: Sharp Semiconductor Innovation Corporation, Tenri City (JP)

(72) Inventors: Motohiro IMADA, Tenri City (JP); Manabu YAMAMOTO, Tenri City (JP)

(21) Appl. No.: 19/305,145

(22) Filed: Aug. 20, 2025

(30) Foreign Application Priority Data
Nov. 27, 2024 (JP) 2024-206270

(51) Int. Cl. H04N 25/78

(52) U.S. Cl. CPC H04N 25/78

(57) ABSTRACT

An imaging device, includes: a pixel configured to accumulate electric charges corresponding to intensity of received light; a ramp voltage generator configured to generate a ramp voltage; a saturation determination voltage generator configured to generate a saturation determination voltage from the ramp voltage; and an analog-to-digital conversion unit configured to perform analog-to-digital conversion for converting, using the ramp voltage, an analog signal indicating an amount of the electric charges into a digital signal, and to determine whether the pixel is saturated in accordance with a result of comparison between a voltage of the analog signal and the saturation determination voltage.

### CROSS-REFERENCE TO RELATED APPLICATION

The present application claims priority from Japanese Application JP2024-206270, the content of which is hereby incorporated by reference into this application.

### BACKGROUND OF THE INVENTION

### 1. Field of the Invention

The present disclosure relates to an imaging device.

### 2. Description of the Related Art

Japanese Unexamined Patent Application Publication No. 2022-082642 discloses an imaging device. In the imaging device, a pixel outputs a potential of first imaging data. A circuit adds the potential of the output first imaging data to a reference potential and supplies a potential signal. The circuit compares a signal potential of the supplied potential signal and the reference potential and determines whether a node of the pixel is saturated. The reference potential is a constant potential corresponding to the saturation of the node of the pixel. If the circuit determines that the node is not saturated, the circuit outputs a result of comparison between the signal potential and a ramp wave to a counter circuit. The counter circuit outputs digital data corresponding to the first imaging data (see paragraphs [0053], [0057], [0060], [0062], and [0063]).

### SUMMARY OF THE INVENTION

As to the imaging device disclosed in Japanese Unexamined Patent Application Publication No. 2022-082642, the reference potential is constant and used for determining whether the node of the pixel is saturated. Hence, the reference potential does not vary even when a slope of the ramp wave changes. Thus, when the slope of the ramp wave changes, the imaging device might not be able to appropriately determine whether the node of the pixel is saturated.

An aspect of the present disclosure is devised in view of the above problem. An aspect of the present disclosure sets out to provide an imaging device capable of, for example, appropriately determining whether a pixel is saturated.

An imaging device according to an aspect of the present disclosure includes:
a pixel that accumulates electric charges corresponding to intensity of received light;
a ramp voltage generator that generates a ramp voltage;
a saturation determination voltage generator that generates a saturation determination voltage from the ramp voltage; and
an analog-to-digital conversion unit that performs analog-to-digital conversion for converting, using the ramp voltage, an analog signal indicating an amount of the electric charges into a digital signal, and that determines whether the pixel is saturated in accordance with a result of comparison between a voltage of the analog signal and the saturation determination voltage.

### BRIEF DESCRIPTION OF THE DRAWINGS

FIG. 1 is a block diagram of an imaging device according to a first embodiment;

FIG. 2 is a graph showing waveforms of a voltage of a pixel signal, a ramp voltage, and a saturation determination voltage input to an analog-to-digital conversion unit included in the imaging device according to the first embodiment;

FIG. 3 is a timing diagram showing the waveforms of the ramp voltage and the saturation determination voltage input to the analog-to-digital conversion unit included in the imaging device according to the first embodiment; and

FIG. 4 is a circuit diagram of a saturation determination voltage generator included in the imaging device of the first embodiment.

### DETAILED DESCRIPTION OF THE INVENTION

An embodiment of the present disclosure will be described below, with reference to the drawings. Note that, throughout the drawings, like reference signs denote identical or similar constituent features. Such features will not be repeatedly elaborated upon.

### 1 First Embodiment

### 1.1 Imaging Device

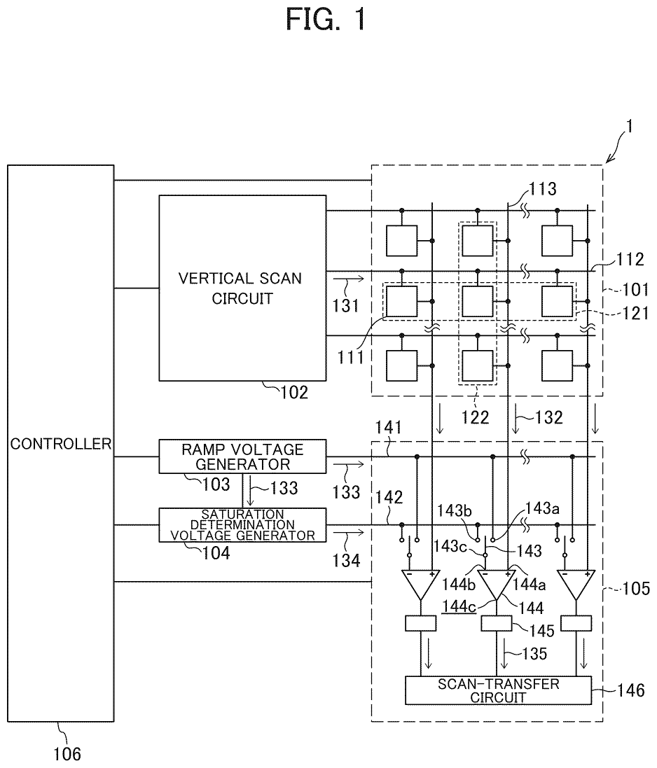

FIG. 1 is a block diagram illustrating an imaging device of a first embodiment.

An imaging device 1 of the first embodiment illustrated in FIG. 1 obtains an image and outputs an image signal corresponding to the obtained image. The imaging device 1 is a solid-state imaging device. The solid-state imaging device is a complementary metal-oxide semiconductor (CMOS) image sensor. Techniques to be described below may be employed for imaging devices other than CMOS image sensors.

As illustrated in FIG. 1, the imaging device 1 includes: a pixel unit 101; a vertical scan circuit 102; a ramp voltage generator 103; a saturation determination voltage generator 104; an analog-to-digital conversion unit 105; and a controller 106.

As illustrated in FIG. 1, the pixel unit 101 includes: m×n pixels 111; m row selection lines 112; and n vertical signal lines 113. Here, m and n are integers of 2 or more.

The m×n pixels 111 are arranged in a matrix. Hence, the m ×n pixels 111 constitute a pixel array of m rows and n columns. Thus, the m ×n pixels 111 include m rows 121 and n columns 122. Each of the m rows 121 has n pixels 111. Each of the n columns 122 has m pixels 111. Each of the m×n pixels 111 has a photodiode. The photodiode receives light, generates signal charges corresponding to intensity of the received light, and accumulates the generated signal charges. The photodiode has an upper limit to the amount of signal charges to be accumulated in the photodiode. Each pixel 111 discharges the accumulated signal charges when the pixel 111 receives a row selection pulse.

Each of the m row selection lines 112 corresponds to one of the m rows 121. Each of the m row selection lines 112 is electrically connected to the vertical scan circuit 102. Each row selection line 112 is electrically connected to the n pixels 111 included in the corresponding row 121. Hence, each of the row selection lines 112 transmits a row selection pulse 131, output by the vertical scan circuit 102, from the vertical scan circuit 102 to the n pixels 111. Then, the row selection line 112 provides the transmitted row selection pulse 131 to the n pixels 111.

Each of the n vertical signal lines 113 corresponds to one of the n columns 122. Each n vertical signal line 113 is electrically connected to the m pixels 111 included in a column 122 corresponding to the vertical signal line 113. Each vertical signal line 113 is electrically connected to the analog-to-digital conversion unit 105. Hence, each of the vertical signal lines 113 transmits an analog signal 132, indicating the amount of signal charges discharged by a pixel 111 included in the m pixels 111, from the pixel 111 to the analog-to-digital conversion unit 105. Then, the vertical signal line 113 provides the transmitted analog signal 132 to the analog-to-digital conversion unit 105. The provided analog signal 132 has a voltage corresponding to intensity of the light received by the pixel 111. The voltage of the analog signal 132 decreases as the intensity of the light received by the pixel 111 increases. An absolute value of the voltage of the analog signal 132 increases as the intensity of the light received by the pixel 111 increases.

The vertical scan circuit 102 scans the pixel unit 101 in a vertical direction. The vertical scan circuit 102 selects one row selection line 112 from the m row selection lines 112 and causes the selected one row selection line 112 to transmit a row selection pulse 131. The vertical scan circuit 102 sequentially changes the one row selection line 112 to be selected.

Hence, each of the pixel unit 101 and the vertical scan circuit 102 provides the analog-to-digital conversion unit 105 with n analog signals 132 indicating the amount of signal charges output by the n pixels 111 included in one row 121 selected from the m rows 121. The pixel unit 101 and the vertical scan circuit 102 sequentially change the one row 121 to be selected. Hence, each of the pixel unit 101 and the vertical scan circuit 102 provides the analog-to-digital conversion unit 105 with m×n analog signals indicating the amount of signal charges output by the m×n pixels 111.

The ramp voltage generator 103 generates a ramp voltage 133 and outputs the generated ramp voltage 133. The output ramp voltage 133 serves as a reference voltage for analog-to-digital conversion; that is, conversion of the analog signal 132 into a digital signal 135.

The saturation determination voltage generator 104 generates a saturation determination voltage 134 and outputs the generated saturation determination voltage 134. The output saturation determination voltage 134 serves as a reference voltage for determining whether a pixel 111 is saturated.

The analog-to-digital conversion unit 105 performs analog-to-digital conversion for converting, using the output ramp voltage 133, each of the provided n analog signals 132 into the digital signal 135. Then, the analog-to-digital conversion unit 105 outputs the digital signal 135. A gradation value represented by the output digital signal 135 increases as a voltage of each of the analog signals 132 decreases, and increases as the absolute value of the voltage of the analog signal 132 increases.

In accordance with a result of comparison between each of the provided analog signals 132 and the output saturation determination voltage 134, the analog-to-digital conversion unit 105 determines whether the pixel 111 that has output the analog signal 132 is saturated. The saturation of the pixel 111 means that the amount of signal charges to be accumulated by the pixel 111 does not increase even if the intensity of the light received by the pixel 111 increases, and that the gradation value represented by the digital signal 135 does not increase even if the intensity of the light received by the pixel 111 increases.

The gradation value represented by the digital signal 135 does not increase even if the intensity of light received by the pixel 111 increases when the voltage of the analog signal 132 output by the pixel 111 falls below a lower limit of a range of the voltage determined by the ramp voltage 133 for the analog-to-digital conversion. Hence, in determining whether the pixel circuit 111 is saturated, the ramp voltage 133 should be taken into consideration. However, if the ramp voltage 133 is not taken into consideration, the saturation determination voltage 134 is fixed, and the saturation determination voltage 134 does not vary even though the ramp voltage 133 varies, the pixel 111 could be falsely determined to be saturated even though the pixel 111 is not actually saturated; alternatively, the pixel 111 could be falsely determined not to be saturated even though the pixel 111 is actually saturated. Hence, in the imaging device 1, the saturation determination voltage generator 104 generates the saturation determination voltage 134 from the ramp voltage 133. The saturation determination voltage generator 104 increases the saturation determination voltage 134 if there is an increase in the lower limit of the range of the voltage for the analog-to-digital conversion, and decreases the saturation determination voltage 134 if there is a decrease in the lower limit of the range of the voltage for the analog-to-digital conversion.

The analog signal 132 output by the pixel unit 101 may be processed, and the processed analog signal may be provided to the analog-to-digital conversion unit 105. The processed analog signal also indicates the amount of signal charges discharged by the pixel 111.

The controller 106 causes the pixel unit 101, the vertical scan circuit 102, the ramp voltage generator 103, the saturation determination voltage generator 104, and the analog-to-digital conversion unit 105 to perform processing to be described below. The controller 106 is an electronic circuit.

When the pixel 111 is saturated, the gradation value represented by the digital signal 135 does not increase even if the intensity of the light received by the pixel 111 increases. Hence, when the pixel 111 is saturated, the digital signal 135 cannot represent the gradation. Hence, when the pixel 111 is saturated, countermeasures are taken such as expanding an expression range of the gradation by a high dynamic range (HDR) technique, changing a condition for accumulating the signal charges so that the gradation value represented by the digital signal 135 falls within the expression range of the gradation, and resetting a photodiode included in the pixel 111 and continuing the accumulation of the signal charges in the photodiode. If the determination is false as to whether the pixel circuit 111 is saturated, the necessity and the timing of the countermeasures cannot be determined appropriately. Hence, the graduation cannot be represented correctly. Thus, it is desirable to reduce the false determination. When the saturation determination voltage 134 is generated from the ramp voltage 133 and the saturation determination voltage 134 is set to follow the ramp voltage 133, the false determination can be reduced so that whether the pixel 111 is saturated can be appropriately determined.

### 1.2 Analog-to-Digital Conversion Unit

As illustrated in FIG. 1, the analog-to-digital conversion unit 105 includes: a ramp voltage transmission line 141; a saturation determination voltage transmission line 142; n switching circuits 143; n comparators 144; n latch counters 145; and a scan-transfer circuit 146. Each of the n switching circuits 143 includes: a first input terminal 143a; a second input terminal 143b; and an output terminal 143c. Each of the n comparators 144 includes: a non-inverting input terminal 144a; an inverting input terminal 144b; and an output terminal 144c.

The ramp voltage transmission line 141 is electrically connected to the ramp voltage generator 103 and to the first input terminal 143a of each of the n switching circuits 143. Hence, the ramp voltage transmission line 141 transmits the ramp voltage 133, which is output by the ramp voltage generator 103, from the ramp voltage generator 103 to the first input terminal 143a of each of the n switching circuits 143. Then, the ramp voltage transmission line 141 inputs the transmitted ramp voltage 133 to the first input terminal 143a of each of the n switching circuits 143.

The saturation determination voltage transmission line 142 is electrically connected to the saturation determination voltage generator 104 and to the second input terminal 143b of each of the n switching circuits 143. Hence, the saturation determination voltage transmission line 142 transmits the saturation determination voltage 134, which is output by the saturation determination voltage generator 104, from the saturation determination voltage generator 104 to the second input terminal 143b of each of the n switching circuits 143. Then, the saturation determination voltage transmission line 142 inputs the transmitted saturation determination voltage 134 to the second input terminal 143b of each of the n switching circuits 143.

Each of the switching circuits 143 switches connection destinations, to which the output terminal 143c of each switching circuit 143 is electrically connected, between the first input terminal 143a and the second input terminal 143b of the switching circuit 143. Hence, each switching circuit 143 switches voltages, to be output from the output terminal 143c of the switching circuit 143, between the ramp voltage 133 and the saturation determination voltage 134.

Each of the n comparators 144 corresponds to one of the n vertical signal lines 113 and to one of the n switching circuits 143. The non-inverting input terminal 144a of each of the comparators 144 is electrically connected to the vertical signal line 113 corresponding to the comparator 144. Hence, the non-inverting input terminal 144a of each comparator 144 receives the analog signal 132 provided from the vertical signal line 113 corresponding to the comparator 144. The inverting input terminal 144b of each of the comparators 144 is electrically connected to the output terminal 143c of the switching circuit 143 corresponding to the comparator 144. Hence, the inverting input terminal 144b of each comparator 144 receives either the ramp voltage 133 or the saturation determination voltage 134 output from the output terminal 143c of the corresponding switching circuit 143.

Each of the comparators 144 sets the voltage output from the output terminal 144c of the comparator 144 to a voltage corresponding to a result of comparison between a voltage input to the non-inverting input terminal 144a of the comparator 144 and a voltage input to the inverting input terminal 144b of the comparator 144. For example, each comparator 144 sets a voltage, to be output from the output terminal 144c of the comparator 144, to a relatively high voltage VH if the voltage input to the non-inverting input terminal 144a of the comparator 144 is higher than the voltage input to the inverting input terminal 144b of the comparator 144. Each comparator 144 sets a volage, to be output from the output terminal 144c of the comparator 144, to a relatively low voltage VL if the voltage input to the non-inverting input terminal 144a of the comparator 144 is lower than the voltage input to the inverting input terminal 144b of the comparator 144. Hence, when the ramp voltage 133 is input to the inverting input terminal 144b of each comparator 144, the comparator 144 sets the voltage, to be output from the output terminal 144c of the comparator 144, to a voltage corresponding to a result of comparison between the voltage of the analog signal 132 transmitted through the vertical signal line 113 corresponding to the comparator 144 and the input ramp voltage 144. When the saturation determination voltage 134 is input to the inverting input terminal 144b of each comparator 144, the comparator 144 sets the voltage, to be output from the output terminal 144c of the comparator 144, to a voltage corresponding to a result of comparison between the voltage of the analog signal 132 transmitted through the vertical signal line 113 corresponding to the comparator 144 and the saturation determination voltage 134.

Each of the n latch counters 145 corresponds to one of the n comparators 144. Each of the n latch counters 145 is electrically connected to the output terminal 144c of the comparator 144 corresponding to the latch counter 145. Hence, each of the latch counters 145 receives the voltage output from the output terminal 144c of the comparator 144 corresponding to the latch counter 145.

Each latch counter 145 counts the number of clocks, latches the counted number of clocks when a change is observed of the result of comparison to be indicated by the input voltage, and outputs the digital signal 135 corresponding to the number of latched clocks. For example, each latch counter 145 latches the counted number of clocks when a change is observed of the input voltage from the relatively high voltage VH to the relatively low voltage VL, and outputs the digital signal 135 representing a gradation value corresponding to the number of latched clocks. The number of clocks to be latched is the number corresponding to the voltage of the analog signal 132 to be input to the non-inverting input terminal 144a of the comparator 144 corresponding to each latch counter 145. Hence, the gradation value represented by the digital signal 135 to be output is a gradation value corresponding to the voltage of the analog signal 132 to be input to the non-inverting input terminal 144a of the comparator 144 corresponding to each latch counter 145. Hence, the n latch counters 145 output the n respective digital signals 135 corresponding to the voltages of the n analog signals 132 to be input to the non-inverting input terminals 144a of the n comparators 144.

The scan-transfer circuit 146 is electrically connected to the n latch counters 145. Hence, the scan-transfer circuit 146 receives the n digital signals 135 output from the n latch counters 145. The scan-transfer circuit 146 scans the n latch counters 145. The scan-transfer circuit 146 selects one latch counter 145 from the n latch counters 145, and transfers a digital signal 135 output by the selected one latch counter 145. The scan-transfer circuit 146 sequentially changes the one latch counter 145 to be selected. The digital signal 135 to be transferred is an image signal.

### 1.3 Waveforms of Voltage of Pixel Signal, Ramp Voltage, and Saturation Determination Voltage

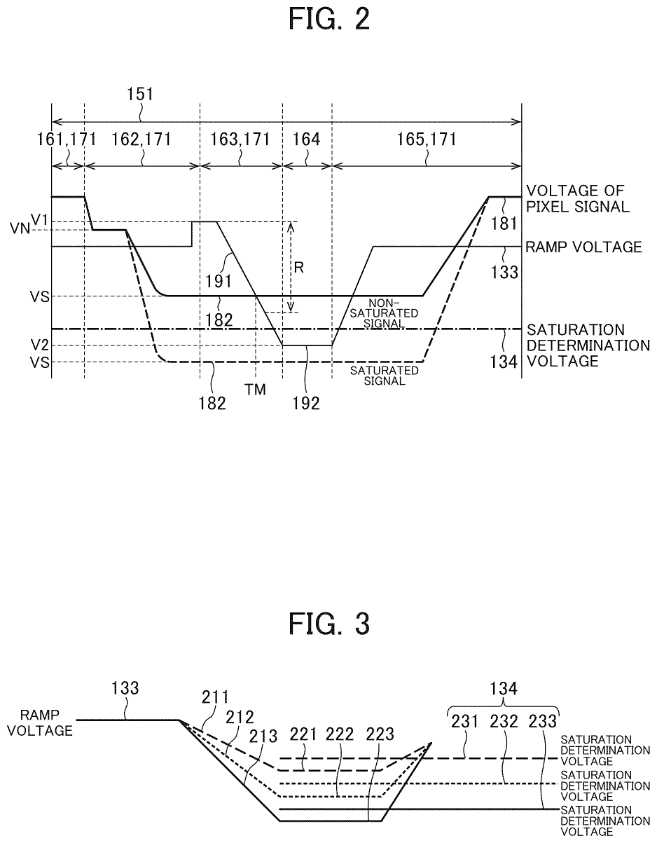

FIG. 2 is a graph showing waveforms of a voltage of a pixel signal, a ramp voltage, and a saturation determination voltage input to an analog-to-digital conversion unit included in the imaging device according to the first embodiment. In the graph of FIG. 2, the horizontal axis represents time, and the vertical axis represents voltage.

In a one-row-read-operation period 151, the imaging device 1 reads the n analog signals 132 from the n respective pixels 111 included in one row 121 selected from the m rows 121, converts the n read analog signals 132 into the n respective digital signals 135, and outputs the n digital signals 135.

As illustrated in FIG. 2, the one-row-read-operation period 151 includes: a reset period 161; a saturation determination period 162; an analog-to-digital conversion period 163; a sampling period 164; and a signal processing period 165.

### Reset Period

In the reset period 161, the vertical scan circuit 102 resets a pixel 111 included in the one row 121 selected from the m rows 121. The reset pixel 111 discharges noise charges and, after that, signal charges. Hence, a voltage 181 of a pixel signal to be output from the pixel 111 falls to a voltage VN corresponding to the amount of the noise charges to be discharged and, after that, to a voltage VS corresponding to the amount of the signal charges to be discharged. Hence, the pixel signal includes an analog signal 132 having the voltage VS corresponding to the amount of the signal charges to be discharged.

In the reset period 161, the ramp voltage generator 103 maintains the ramp voltage 133.

In the reset period 161, the saturation determination voltage generator 104 holds a constant voltage 192 sampled in the sampling period 164 included in a previous one-row-read-operation period 151, and generates the saturation determination voltage 134 corresponding to the held constant voltage 192.

### Saturation Determination Period

In the saturation determination period 162 following the reset period 161, each of the switching circuits 143 sets a connection destination, to which the output terminal 143c of the switching circuit 143 is electrically connected, to the second input terminal 143b of the switching circuit 143. Hence, the inverting input terminal 144b of each comparator 144 receives the saturation determination voltage 134. Each comparator 144 sets a voltage, to be output from the output terminal 144c of the comparator 144, to the relatively high voltage VH if the pixel signal is a non-saturated signal as indicated by a solid line and the voltage VS of the analog signal 132 is higher than the saturation determination voltage 134. Each comparator 144 sets a voltage, to be output from the output terminal 144c of the comparator 144, to the relatively low voltage VL if the pixel signal is a saturated signal as indicated by a dashed line and the voltage VS of the analog signal 132 is lower than the saturation determination voltage 134.

In the saturation determination period 162, the ramp voltage generator 103 sets the ramp voltage 133 to a start voltage V1.

In the saturation determination period 162, the saturation determination voltage generator 104 holds the constant voltage 192 sampled in the sampling period 164 included in the previous one-row-read-operation period 151, and generates the saturation determination voltage 134 corresponding to the held constant voltage 192.

Analog-to-digital Conversion Period

In the analog-to-digital conversion period 163 following the saturation determination period 162, each of the switching circuits 143 sets a connection destination, to which the output terminal 143c of the switching circuit 143 is electrically connected, to the first input terminal 143a of the switching circuit 143. Hence, the inverting input terminal 144b of each comparator 144 receives the ramp voltage 133. If a voltage 182 of the analog signal 132 is higher than the ramp voltage 133, each comparator 144 sets the voltage, to be output from the output terminal 144c of the comparator 144, to the relatively high voltage VH. If the voltage of the analog signal 132 is lower than the ramp voltage 133, each comparator 144 sets the voltage, to be output from the output terminal 144c of the comparator 144, to the relatively low voltage VL.

In the analog-to-digital conversion period 163, the ramp voltage generator 103 decreases the ramp voltage 133 from the start voltage V1 to an end voltage V2 at a constant voltage-value time-variation rate. Hence, the ramp voltage 133 includes a slope voltage 191 having a constant voltage-value time-variation rate. The start voltage V1 is higher than a voltage VN corresponding to the amount of noise charges to be discharged. The end voltage V2 is lower than the saturation determination voltage 134. Hence, if the pixel signal is a non-saturated signal as indicated by the solid line, levels of the slope voltage 191 and the voltage 182 of the analog signal 132 are inverted in the analog-to-digital conversion period 163. However, if the pixel signal is a saturated signal as indicated by the dashed line, the levels of the slope voltage 191 and the voltage 182 of the analog signal 132 might not be inverted in the analog-to-digital conversion period 163.

In the analog-to-digital conversion period 163, the latch counter 145: starts counting the number of clocks in synchronization with the start of decreasing the ramp voltage 133 from the start voltage V1 to the end voltage V2; latches the number of clocks counted in synchronization with the inversion of the levels of the slope voltage 191 and the voltage 182 of the analog signal 132 and the resulting change of the voltage, to be output from the output terminal 144c of each comparator 144, from the relatively high voltage VH to the relatively low voltage VL; and outputs the digital signal 135 corresponding to the number of latched clocks. Hence, when the analog-to-digital conversion is performed and the analog signal 132 is converted into the digital signal 135 at a timing TM at which the levels of the slope voltage 191 and the voltage 182 of the analog signal 132 are inverted, the end voltage V2 decreases with an increase in an absolute value of the voltage-value time-variation rate of the slope voltage 191. Accordingly, there is a decrease in a lower limit of a voltage range R for the analog-to-digital conversion.

In the analog-to-digital conversion period 163, the saturation determination voltage generator 104 holds the constant voltage 192 sampled in the sampling period 164 included in the previous one-row-read-operation period 151, and generates the saturation determination voltage 134 corresponding to the held constant voltage 192.

When the saturation determination voltage 134 is varied in accordance with variations of the voltage-value time-variation rate of the slope voltage 191, the risk of the false determination can be reduced as to whether the pixel 111 is saturated because the lower limit of the voltage range R for the analog-to-digital conversion decreases with an increase in the absolute value of the voltage-value time-variation rate of the slope voltage 191.

### Sampling Period

In the sampling period 164 following the analog-to-digital conversion period 163, the ramp voltage generator 103 sets the ramp voltage 133 to the constant voltage 192 having a constant voltage value. Hence, the ramp voltage 133 includes the constant voltage 192 having a constant voltage value. The constant voltage value of the constant voltage 192 is the same as a voltage value of the end voltage V2. The ramp voltage generator 103 generates the constant voltage 192, after generating the slope voltage 191. As described before, the end voltage V2 decreases with an increase in the absolute value of the voltage-value time-variation rate of the slope voltage 191. Hence, the constant voltage 192 having the same constant voltage as the voltage value of the end voltage V2 decreases with an increase in the absolute value of the voltage-value time-variation rate of the slope voltage 191.

In the sampling period 164, the saturation determination voltage generator 104 samples the constant voltage 192, and generates the saturation determination voltage 134 from the sampled constant voltage 192. The saturation determination voltage 134 to be generated is a voltage corresponding to the sampled constant voltage 192. For example, the saturation determination voltage 134 is generated by amplifying or shifting the sampled constant voltage 192. As described before, the constant voltage 192, which is a basis for generation of the saturation determination voltage 134, decreases with an increase in the absolute value of the voltage-value time-variation rate of the slope voltage 191. Hence, the saturation determination voltage 134 decreases with an increase in the absolute value of the voltage-value time-variation rate of the slope voltage 191.

### Signal Processing Period

In the signal processing period 165 following the sampling period 164, the scan-transfer circuit 146 selects one latch counter 145 from the n latch counters 145, and transfers a digital signal output by the selected one latch counter 145. The scan-transfer circuit 146 sequentially changes the one latch counter 145 to be selected.

In the signal processing period 165, the ramp voltage generator 103 raises, and then maintains, the ramp voltage 133.

In the signal processing period 165, the saturation determination voltage generator 104 holds the constant voltage 192 sampled in the sampling period 164, and generates the saturation determination voltage 134 corresponding to the held constant voltage 192.

### 1.4 Relationship between Ramp Voltage and Saturation Determination Voltage

FIG. 3 is a timing diagram showing the waveforms of the ramp voltage and the saturation determination voltage input to the analog-to-digital conversion unit included in the imaging device according to the first embodiment. In the timing diagram of FIG. 3, the horizontal axis represents time, and the vertical axis represents voltage.

The voltage-value time-variation rate of the slope voltage 191 varies. Hence, as illustrated in FIG. 3, the slope voltage 191 can become such a voltage as: a first slope voltage 211 having a first voltage-value time-variation rate; a second slope voltage 212 having a second voltage-value time-variation rate steeper than the first voltage-value time-variation rate; or a third slope voltage 213 having a third voltage voltage-value time-variation rate steeper than the second voltage-value time-variation rate. Hence, the constant voltage 192, which is generated and sampled after the slope voltage 191 is generated, can become such a voltage as: a first constant voltage 221; a second constant voltage 222 lower than the first constant voltage 221; or a third constant voltage 223 lower than the second constant voltage 222. When the constant voltage 192 becomes such a voltage as the first constant voltage 221, the second constant voltage 222, or the third constant voltage 223, the saturation determination voltage generator 104 sets the saturation determination voltage 134 to such a voltage as a first saturation determination voltage 231, a second saturation determination voltage 232 lower than the first saturation determination voltage 231, or a third saturation determination voltage 233 lower than the second saturation determination voltage 232, so that whether the pixel 111 is saturated is appropriately determined even if the slope voltage 191 becomes such a voltage as the first slope voltage 211, the second slope voltage 212, or the third slope voltage 213.

### 1.5 Waveforms of Analog Signal, Ramp Voltage, and Saturation Determination Voltage

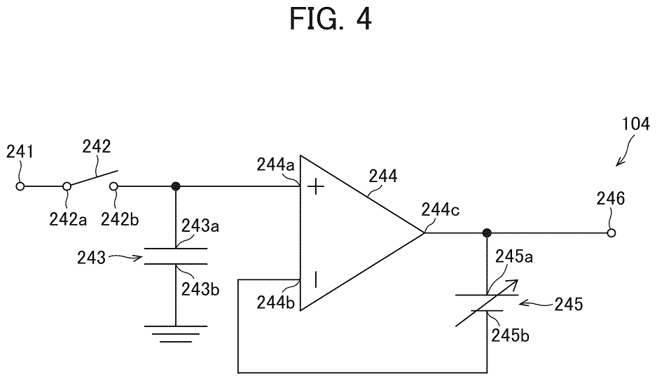

FIG. 4 is a circuit diagram of a saturation determination voltage generator included in the imaging device of the first embodiment.

The saturation determination voltage generator 104 illustrated in FIG. 4 samples the input constant voltage 192, holds the sampled constant voltage 192, shifts the held constant voltage 192 to generate the saturation determination voltage 134, and outputs the generated saturation determination voltage 134.

The saturation determination voltage generator 104 includes: an input terminal 241; a switch 242; a capacitor 243; an operational amplifier 244; a voltage supply 245; and an output terminal 246. The switch 242 includes: a terminal 242 a; and a terminal 242b. The capacitor 243 includes: a terminal 243a; and a terminal 243b. The operational amplifier 244 includes: a non-inverting input terminal 244a; an inverting input terminal 244b; and an output terminal 244c. The voltage supply 245 includes: a positive electrode 245a; and a negative electrode 245b.

The input terminal 241 is electrically connected to the ramp voltage generator 103. The terminal 242a of the switch 242 is electrically connected to the input terminal 241. The terminal 243a of the capacitor 243 and the non-inverting input terminal 244a of the operational amplifier 244 are electrically connected to the terminal 242b of the switch 242. The terminal 243b of the capacitor 243 is grounded.

The switch 242 is closed during the sampling period 164 illustrated in FIG. 2 and open during the hold period 171 illustrated in FIG. 2. The hold period 171 is a period other than the sampling period 164. Hence, in the sampling period 164, the terminal 242b of the switch 242 is in conduction to the terminal 242a of the switch 242, the constant voltage 192 is applied through the input terminal 241 and the switch 242 to the terminal 243a of the capacitor 243, and the capacitor 243 accumulates electric charges an amount of which corresponds to the constant voltage 192.

In the hold period 171, the terminal 242b of the switch 242 is out of conduction from the terminal 242a of the switch 242, a voltage corresponding to the amount of the electric charges accumulated in the capacitor 243 is generated at the terminal 243a of the capacitor 243, and the generated voltage is input to the non-inverting input terminal 244a of the operational amplifier 244. The voltage, which is generated at the terminal 243a of the capacitor 243 and input to the non-inverting input terminal 244a of the operational amplifier 244, matches the constant voltage 192.

The negative electrode 245b of the voltage supply 245 is electrically connected to the inverting input terminal 244b of the operational amplifier 244. The positive electrode 245a of the voltage supply 245 is electrically connected to output terminal 244c of the operational amplifier 244. The output terminal 246 is electrically connected to the output terminal 244c of the operational amplifier 244 and to the positive electrode 245a of the voltage supply 245. Hence, the voltage to be output from the output terminal 244c of the operational amplifier 244 becomes a voltage obtained by adding a voltage generated by the voltage supply 245 to the constant voltage 192 to be input to the non-inverting input terminal 244a of the operational amplifier 244, that is, a voltage obtained by shifting the constant voltage 192 to be input to the non-inverting input terminal 244a of the operational amplifier 244. Thus, the voltage obtained by shifting the constant voltage 192 is output from the output terminal 246.

The present disclosure shall not be limited to the above-described embodiment, and may be replaced with a configuration substantially the same as a configuration having the same advantageous effects as, or a configuration capable of achieving the same object as, the configurations described in the above-described embodiment.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An imaging device, comprising:
a pixel configured to accumulate electric charges corresponding to intensity of received light;
a ramp voltage generator configured to generate a ramp voltage;
a saturation determination voltage generator configured to generate a saturation determination voltage from the ramp voltage; and
an analog-to-digital conversion unit configured to perform analog-to-digital conversion for converting, using the ramp voltage, an analog signal indicating an amount of the electric charges into a digital signal, and to determine whether the pixel is saturated in accordance with a result of comparison between a voltage of the analog signal and the saturation determination voltage.

2. The imaging device according to claim 1,
wherein the ramp voltage includes: a slope voltage having a constant voltage-value time-variation rate; and a constant voltage having a constant voltage value,
the ramp voltage generator generates the constant voltage, after generating the slope voltage, and
the performing the analog-to-digital conversion for converting, using the ramp voltage, the analog signal into the digital signal includes performing the analog-to-digital conversion for converting the analog signal into the digital signal at a timing at which levels of the slope voltage and the voltage of the analog signal are inverted, and
the generating the saturation determination voltage from the ramp voltage includes generating the saturation determination voltage from the constant voltage.

3. The imaging device according to claim 2,
wherein the generating the saturation determination voltage from the constant voltage includes generating the saturation determination voltage by amplifying or shifting the constant voltage.

4. The imaging device according to claim 1,
wherein the ramp voltage includes a slope voltage having a constant voltage-value time-variation rate,
the performing the analog-to-digital conversion for converting, using the ramp voltage, the analog signal into the digital signal includes performing the analog-to-digital conversion for converting the analog signal into the digital signal at a timing at which levels of the slope voltage and the voltage of the analog signal are inverted, and
the generating the saturation determination voltage from the ramp voltage includes varying the saturation determination voltage in accordance with variations of the voltage-value time-variation rate of the slope voltage.
